(19) United States
(12) Patent Application Publication
(10) Pub. No.: US 2024/0189832 A1
(43) Pub. Date: Jun. 13, 2024

(54) Adapter For A Centrifuge Rotor And Corresponding Kits And Methods

(71) Applicant: Thermo Electron LED GmbH, Osterode (DE)

(72) Inventor: Norman BALLHAUSE, Osterode (DE)

(21) Appl. No.: 18/530,967

(22) Filed: Dec. 6, 2023

(30) Foreign Application Priority Data
Dec. 8, 2022 (EP) EP22212342.4

(51) Int. Cl. B04B 5/04; B04B 7/12

(52) U.S. Cl. CPC B04B 5/0414; B04B 7/12

(57) ABSTRACT

An adaptor for a centrifuge rotor is provided. The adaptor comprises: a body comprising a plurality of bores arranged in a row each having a first diameter and each bore for receiving a first sample container; and a primary protrusion extending from the body. The primary protrusion has a second diameter and the primary protrusion is for being received in a rotor bore of a centrifuge rotor. The rotor bore is for receiving second sample containers.

### BACKGROUND

The present specification relates to an adaptor for a centrifuge rotor, as well as a rotor kit and a centrifuge kit incorporating this adaptor. The specification also relates to corresponding methods of adapting a centrifuge rotor and processing a sample container.

The use of centrifuges is well known, whereby a centrifuge rotor (also referred to as a rotor) is rotated at speed to separate components of a sample.

The sample is provided in a sample container, which can vary in size. A particular rotor will typically be sized to receive one or more sample container sizes within a plurality of rotor bores, and not other sample container sizes. Rotors for a centrifuge may therefore be switched in and out based on the size of the sample containers to be centrifuged.

Centrifuges themselves may be categorised based on their size and the size of sample containers they are intended to receive. This can be based on, for example, the rotors which they are compatible with. For example, “microliter” centrifuges may be sized and arranged to process microlitre tubes, for examples tubes of 0.1 ml to 2.0 ml, in particular 0.2 ml. While a “general purpose” centrifuge may be used for larger tube sizes, such as 5 ml, 10 ml, 15 ml, and up to 250 ml or 500 ml. Centrifuges may additionally, or alternatively, be categorised based on their optimized operational speed. For example, an “ultracentrifuge” may be provided for generating rotation as fast as 150,000 rpm.

Adaptors such as shown in FIG. 3 have been used to adapt a rotor bore of a rotor to accommodate a sample container which is sized differently to the rotor bore. However, an adaptor is needed for each rotor bore which means that this is not a particularly efficient system.

In recent years, polymerase chain reaction (PCR) has become a known method for creating copies of a DNA sample. This allows a small DNA sample to be taken, which is then copied until a sufficiently large amount of the DNA sample is available for testing. Typically, PCR is performed using special PCR tubes which are provided in a strip as shown in FIG. 1. The individual PCR tubes are arranged in a straight line in this strip.

In typical rotors, the rotor bores which receive the sample containers are arranged in a circular pattern centred on a centre of the rotor. This means that the rotor bores are not arranged in a straight line. As a result, such traditional rotors are not suitable for PCR strips.

Instead, specially designed PCR rotors have been used such as shown in FIG. 2. The rotor bores of such a PCR rotor are arranged in a straight line so as to receive a PCR strip. Again, this means that to use a centrifuge with a PCR strip the rotor of the centrifuge needs to be changed.

Further, the adaptor as shown in FIG. 3 would not resolve this as even if each rotor bore in a traditional rotor were provided with such an adaptor the adaptors would not be arranged in a straight line as they would maintain the circular arrangement of the traditional rotor. As a result, the traditional rotor cannot be readily adapted for use with PCR strips.

In practice, this leads to many users having multiple centrifuges—one for PCR and one for other operations—as the regular changing of the rotor is inefficient.

There is therefore a need for an improved adaptor.

### SUMMARY

An adaptor for a centrifuge rotor is provided according to claim 1. This adaptor allows for a centrifuge rotor to be readily adapted to a different sample container, particularly one that is suitable for sample containers arranged in a strip, such as PCR strips.

The plurality of bores may comprise three or more bores, preferably eight or more bores, more preferably eight or more bores. In particular examples, the plurality of bores may be exactly 8 bores or exactly 12 bores. This can allow a suitable number of sample containers to be used with the adaptor. This may correspond to the typical number of sample containers in a strip for a particular type.

The second diameter may be greater than the first diameter. This allows the adaptor to convert for a smaller sample container to be used with the rotor, such as a smaller PCR container being used with a rotor for larger sample containers.

The body may extend transverse to the primary protrusion. Preferably the body may extend perpendicular to the primary protrusion. This is an effective shape for the adaptor, particularly in establishing straight lines for processing sample containers in a strip.

The first diameter may correspond to an outer diameter of a PCR tube. The adaptor is particularly useful for PCR tubes as the intended sample containers—particularly PCR strips.

The second diameter may correspond to a 0.5 millilitre (0.5 mL) to 2 millilitre (2 mL) sample container, or a 3 millilitre (3 mL) sample container. This is a common size for sample containers in rotors that may be adapted using the present adaptor.

The primary protrusion may be formed as a cylindrical protrusion. This can generally correspond to the shape of the sample containers intended to be used with the rotor.

The primary protrusion may have a domed surface at its distal end. This can further generally correspond to the shape of the sample containers intended to be used with the rotor.

The adaptor may comprise a plurality of primary protrusions including the primary protrusion, each primary protrusion for being received in a rotor bore of a centrifuge rotor and being arranged on a segment of a circular arc. Multiple primary protrusions can improve the security of the adaptor. Having the primary protrusions on a circular arc, which may correspond to the circular arrangement of the rotor bores of the rotor, means that the primary protrusions can fully engage a corresponding rotor bore in this circular arrangement.

The plurality of primary protrusions may comprise two primary protrusions. That may be exactly two primary protrusions. Two primary protrusions can lead to a particularly secure adaptor. For example, with a primary protrusion at either end of the body.

The adaptor may further comprise one or more secondary protrusion(s), each for being received in a further rotor bore of the centrifuge rotor. The secondary protrusion(s) can help to secure the adaptor to the rotor.

Each secondary protrusion may be angled with respect to the (or each) primary protrusion. Angled secondary protrusions allow them to engage with rotor bores at an angle to the body of the adaptor.

Each secondary protrusion may be tapered towards its distal end. This tapering can mean that the secondary protrusions can be shaped to contact a wall of the rotor bore along their length.

Each secondary protrusion may be shorter than the (or each) primary protrusion. The secondary protrusions do not need to fully extend into the corresponding bore as they are providing secondary support to the primary protrusions.

The adaptor may comprise two secondary protrusions, with the primary protrusion arranged centrally. This a particularly stable arrangement for the adaptor.

A rotor kit is provided according to claim 12. This is a rotor kit which can be used with a centrifuge to allow the centrifuge to be easily adaptable for different sample containers. The rotor bores may be sized and configured to receive a 0.5 millilitre (0.5 mL) to 2 millilitre (2 mL) sample container, or a 3 millilitre (3 mL) sample container.

A centrifuge kit is provided according to claim 13. This is a centrifuge kit which can allow the centrifuge to be easily adaptable for different sample containers. The rotor bores may be sized and configured to receive a 0.5 millilitre (0.5 mL) to 2 millilitre (2 mL) sample container, or a 3 millilitre (3 mL) sample container.

A method of adapting a centrifuge rotor comprising a plurality of rotor bores is provided according to claim 14. This method quickly and effectively adapts the centrifuge rotor for different sample containers. The rotor bores may be sized and configured to receive a 0.5 millilitre (0.5 mL) to 2 millilitre (2 mL) sample container, or a 3 millilitre (3 mL) sample container.

A method of processing a sample container in a centrifuge, the centrifuge comprising a centrifuge rotor comprising a plurality of rotor bores, is provided according to claim 15. This method allows for sample containers which otherwise may not fit in the rotor bore of the rotor to be centrifuged with the centrifuge. The rotor bores may be sized and configured to receive a 0.5 millilitre (0.5 mL) to 2 millilitre (2 mL) sample container, or a 3 millilitre (3 mL) sample container.

### BRIEF DESCRIPTION OF THE DRAWINGS

The present specification makes reference to the accompanying drawings, by way of example only, in which:

FIG. 1 shows a perspective view of a PCR strip;

FIG. 2 shows a perspective view of a centrifuge rotor for a PCR strip;

FIG. 3 shows a perspective view of a known adaptor for a centrifuge rotor;

FIG. 4 shows a perspective view of an adaptor for a centrifuge rotor;

FIG. 5 shows a perspective view of a centrifuge rotor which has four adaptors of FIG. 4 inserted;

FIG. 6 shows a perspective view of a centrifuge rotor in partial transparency which has an adaptor of FIG. 4 inserted; and

FIG. 7 shows a close-up perspective view of the centrifuge rotor in partial transparency and adaptor of FIG. 6.

### DETAILED DESCRIPTION

As briefly discussed above, centrifuges are used to separate components of a fluid in a sample container by spinning/rotating the sample container (and hence the fluid) at a high speed. Of course, there may be solid components within the fluid such as in suspension or dissolved therein. The centrifuge comprises a rotor which is the component that rotates. The rotor includes a plurality of rotor bores arranged generally in a circle around a centre of the rotor. The rotor is, in use, rotated about this centre. In certain examples the rotor may include one or more layers of rotor bores, arranged in concentric circles around the centre of the rotor.

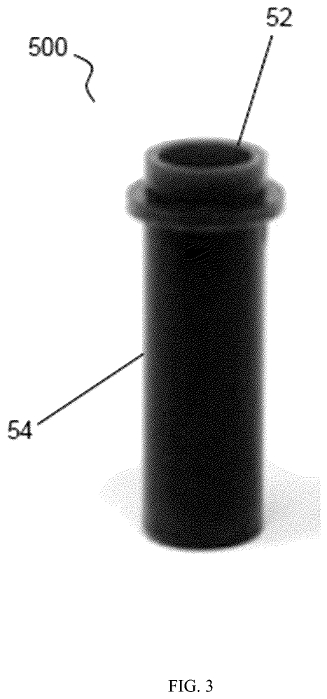

The rotor bores of the rotor will be sized for a particular sample container size, with other sample containers not suitable to be used with that rotor. This either requires replacement of the rotor or the use of an adaptor to switch between different sample container sizes. FIG. 3 shows an example of an adaptor 500 used to modify a rotor bore to accept a smaller sample container. This adaptor 500 includes an outer surface 54. The outer surface 54 generally corresponds to the sample container intended to be received by the rotor bore. For example, the outer surface 54 may have the same diameter as the intended sample container. The adaptor 500 then further comprises an adaptor bore 52. The adaptor bore 52 may be smaller than the rotor bore into which the adaptor 500 is inserted. As a result, different sample containers can then be inserted into the adaptor bore 52.

In this sense, the adaptor 500 allows the rotor to be used with different sample containers without requiring replacement of the rotor in the centrifuge. However, such adaptors are still constrained by the physical arrangement of the rotor bores on the rotor. This is particularly an issue with new techniques which use specific types of sample container, such as the polymerase chain reaction (PCR).

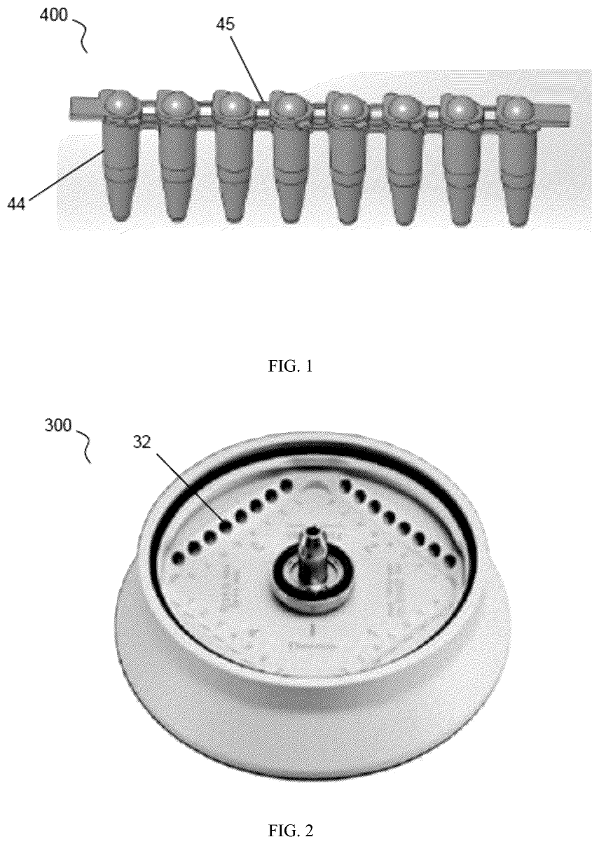

FIG. 1 shows a strip 400 of PCR sample containers (or tubes) 44. This strip 400 may commonly be referred to as a PCR strip 400. The PCR strip 400 comprises a number of PCR tubes 44 joined together by one or more connecting sections 45. The connecting sections 45 may be integral/unitary with the PCR tubes 44, or separately provided. Each PCR tube 45 may have a standard volume, for example of 0.1 mL or 0.2 mL. A PCR strip 400 may have any number of PCR tubes 44. In particular examples, the PCR strip 400 may be formed of 8 PCR tubes 44 or 12 PCR tubes 44. It is also common for users to cut a PCR strip 400 into a number of PCR tubes 44 required, so the PCR strip 400 in use may have any number of PCR tubes 44. The tubes 44 are arranged in a generally straight line.

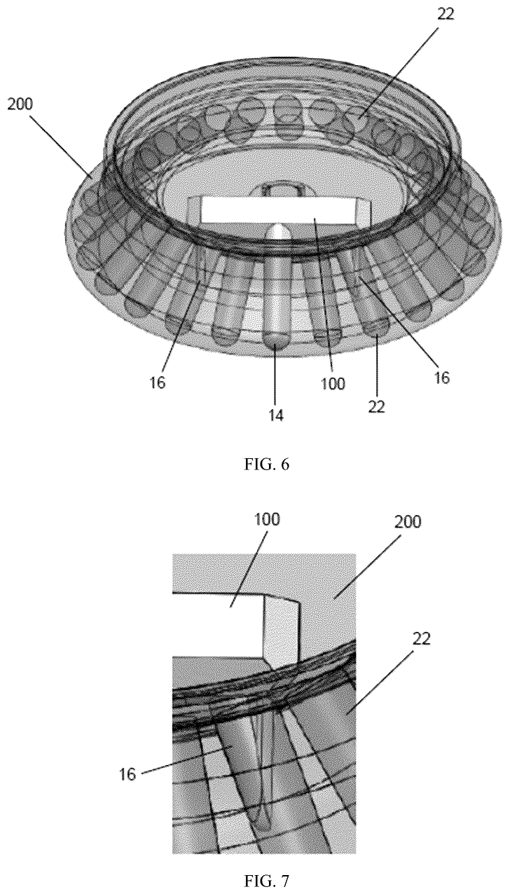

As a part of the PCR, these PCR strips 400 are typically centrifuged—for example after mixing and/or after one or more PCR cycles. FIG. 2 shows a PCR rotor 300 for a centrifuge. This PCR rotor 300 may be used to receive a PCR strip 400, and then rotated to centrifuge the PCR strip 400. As can be seen in FIG. 2, contrary to the arrangement of a conventional rotor discussed above, the rotor bores 32 are arranged in rows. That is, not in the circular arrangement of a conventional rotor. Such a circular arrangement can be seen, for example, in FIG. 6.

Collectively, a plurality of rows of rotor bores 32 may be provided on the PCR rotor 32, effectively defining a square centred on the centre of the PCR rotor 32. As shown in FIG. 2, the rows may not extend all the way to the corners of this square, but can be conceptually extended so as to define the square. In certain examples, multiple rows of rotor bores 32 may be provided, for example to define a plurality of squares each of which may be centred on a centre of the PCR rotor 32.

FIG. 2 shows each row having 8 rotor bores 32. However, any number of rotor bores 32 may be used in a row including, for example, 12 rotor bores 32.

In order to use this PCR rotor 300, either a conventional rotor must be switched out from a centrifuge, or as commonly happens in practice a specific PCR centrifuge is used which always has a PCR rotor 300 installed. Even incorporating an adaptor 500 such as shown in FIG. 3, a standard rotor of a centrifuge would not be suitable to receive such a PCR strip 400. As noted above, the rotor bores of the centrifuge are arranged in a circle centred on a centre of the rotor. This arrangement would be maintained when the adaptors 500 are inserted. With this circular arrangement, the straight strip 400 of PCR tubes 44 could not be received.

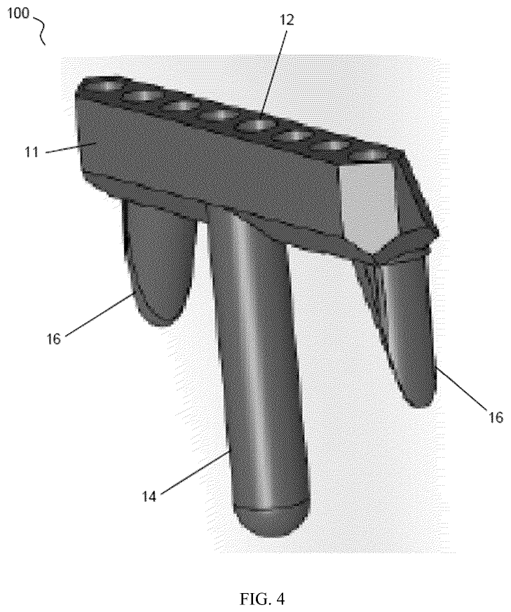

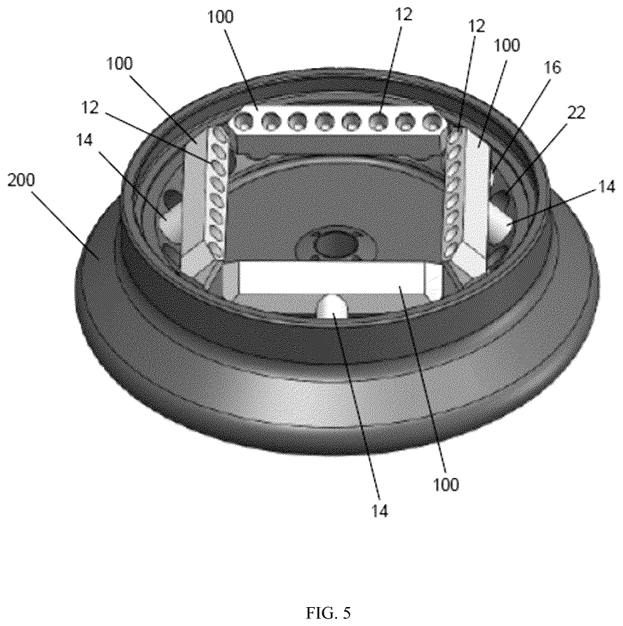

To address this, an adaptor 100 for a centrifuge rotor such as shown in FIG. 4 may be provided. FIG. 4 shows the adaptor 100 in isolation, while FIGS. 5 to 7 show the adaptor 100 received within a centrifuge rotor 200.

The adaptor 100 comprises an adaptor body 11. This body 11 may be generally elongate, for example in the form of an elongate block. The body 11 can be elongate in a longitudinal direction. In this body 11, a plurality of adaptor bores 12 are formed. The adaptor bores 12 may be formed in the body 11 by any suitable means, including drilling or machining, or the body 11 may be moulded to incorporate these bores 12. In certain examples, the body 11 may include first and second elongate sections, each elongate in different directions. For example, the first elongate section may be transverse or perpendicular to the second elongate section.

The body 11 may comprise any number of bores 12. For example, this may be 3 or more bores 12, 5 or more bores 12 or 8 or more bores 12. In particular examples, the body 11 may have exactly 8 bores 12 or 12 bores 12. This may correspond to the typical number of sample containers to be received by the adaptor 100.

Each of the bores 12 has a first diameter. That is, a first distance between internal walls of the bore 12. In certain examples, the bore 12 may have a varied diameter along its depth. For example, the bore 12 may taper away from its opening. In such examples, the first diameter may be defined at any suitable point, for example at an opening of the bore 12.

Each bore 12 is suitable for receiving a first sample container. In certain examples, the first sample container may be a PCR tube 44, such as a PCR tube 44 within a PCR strip 400. That is, the bore 12 may be shaped to correspond to an outer shape and/or size of the first sample container. In other words, the first diameter may be generally the same as an outer diameter of the first sample container. Of course, there may be some leeway to allow for the first sample container to be inserted and/or removed and so the first diameter may be greater than the outer diameter of the first sample container, for example by a small amount such as 10% or less of the outer diameter.

The bores 12 are arranged in a row. That is, the bores 12 may be arranged in a generally straight line on the adaptor 100. A centre of each bore 12 may be defined, with each centre laying on this straight line. This straight line may extend in the same direction in which the body 11 is elongate. The row can extend in a first direction. This first direction can also correspond to a longitudinal direction of the body 11.

The adaptor 100 comprises a primary protrusion 14. The primary protrusion 14 extends away from the adaptor body 11. This may be, for example, in a second direction which is generally transverse to the first direction. In certain examples, the second direction may be perpendicular to the first direction. The body 11 can extend transverse to the primary protrusion 14. In certain examples, the body 11 can extend perpendicular to the primary protrusion 14. In effect, the body 11 and primary protrusion 14 can form a “T” shape in side-view. A proximal end of the primary protrusion 14 can be identified at the body 11, with a distal end of the primary protrusion 14 away from the body 11.

The primary protrusion 14 has a second diameter. This second diameter may be in certain examples greater than the first diameter of the bores 12. Alternatively, the second diameter may be the same or less than the first diameter.

The primary protrusion 14 is suitable for being received in a rotor bore 22 of a centrifuge rotor 200 such as shown in FIGS. 5 and 6. This may be, for example, a conventional centrifuge rotor 200 in which the rotor bores 22 are arranged in a circular pattern. The rotor bores 22 may be configured to receive second sample containers of a different size/shape/arrangement to the first sample containers received in the adaptor 100. The primary protrusion 14 may be shaped and/or sized to correspond to these second sample containers. For example, the second diameter of the primary protrusion 14 may be generally the same as an outer diameter of these second sample containers which the rotor bores 22 are intended to receive.

The primary protrusion 14 may extend into most of the volume of the rotor bore 22 in use, for example over 50% of the rotor bore 22 or over 75% of the rotor bore 22. FIG. 6 shows the primary protrusion 14 received in a rotor bore 22, with the primary protrusion 14 substantially filling the rotor bore 22.

In certain examples, the second sample containers may be a 0.5 mL to 2 mL sample container, or a 3 mL sample container, and the primary protrusion 14 shaped and sized accordingly. That is, the outer diameter of the primary protrusion 14 may generally be the same as a 0.5 mL to 2 mL sample container, or a 3 mL sample container.

In general, the primary protrusion 14 may be shaped as a generally cylindrical protrusion. The primary protrusion 14 may have generally the same diameter along its length, or it may vary. This can be selected based on the shape of the rotor bore 22 in which it is to be received. The primary protrusion 14 may further comprise a domed surface at its distal end. This domed surface may, for example, be a hemisphere.

While FIG. 4 shows the adaptor 100 having a single primary protrusion 14 (and additional secondary protrusions 16 discussed below), it is also anticipated that there may be a plurality of primary protrusions 14. Each of these primary protrusions 14 may be configured to be received in a rotor bore 22 of a centrifuge rotor 200. For example, each primary protrusion 14 may be arranged on a segment of a circular arc. This can therefore allow each primary protrusion 14 to be received in a corresponding rotor bore 22 which is arranged in a circular arrangement. This may require one or more of the primary protrusions 14 to be angled with respect to one another. Each additional primary protrusion 14 may be as described above in relation to the primary protrusion 14 of FIG. 4.

In particular examples, there may be exactly two primary protrusions 14. For example, these two primary protrusions 14 may be arranged at opposite ends of the body 11. This contrasts to FIG. 4 where the single primary protrusion 14 is provided at a longitudinal centre of the body 11. In further examples, there may be a primary protrusion 11 at a longitudinal centre of the body 11 as well as further primary protrusions 11 at other locations, such as one at each end of the body 11.

With such an adaptor 100, it can be placed into a conventional rotor 200 such as shown in FIGS. 5 and 6. This then adapts the conventional rotor 200 to receive the first sample containers, such as the PCR containers 44 and PCR strip 400. While the adaptor 100 in some examples may be used to accommodate differently sized, such as smaller, sample containers, it is also anticipated that the adaptor 100 could be used to accommodate different shapes (i.e. outer shape) of sample container, and/or different arrangements—such as the strip arrangement of a PCR strip 400 or any other arrangement.

As shown in FIG. 5, a plurality of adaptors 100 may be inserted into the rotor 200. The plurality of adaptors 100 may be arranged with rotational symmetry about the rotor 200. For example, FIG. 5 shows 4 rotors arranged with four-fold rotational symmetry. In this sense, the rotor 200 incorporating the adaptors 100 of FIG. 5 can be seen to be generally similar to the PCR rotor 300 of FIG. 2.

In addition to, or alternatively to, the primary protrusion 14 discussed above, the adaptor 100 may further comprise one or more secondary protrusions 16. The secondary protrusions 16 may extend away from the body 100. While FIG. 4 shows the adaptor 100 having both primary protrusions 14 and secondary protrusions 16 this is not necessarily the case and examples are also considered with only secondary protrusions 16. Of course, in such examples the secondary protrusions 16 could be nominally identified as “primary protrusions”. That is, a primary protrusion 14 as discussed above may have any of the characteristics discussed in relation to the nominal secondary protrusions 16.

Each of the secondary protrusions 16 are suitable for being received in a rotor bore 22 of the centrifuge rotor 200. That may be a further rotor bore 22 to the rotor bore 22 that the primary protrusion 14 is received in. The secondary protrusions 16 may be arranged on a generally straight line with the primary protrusion 14. For example, a centre of each secondary protrusion may be arranged on a straight line along with a centre of the primary protrusion 14. This centre may be defined at the point at which the secondary protrusion 16 or the primary protrusion 16 extends from the body 11.

FIG. 4 shows a particular example adaptor 100 which includes two secondary protrusions 16. These secondary protrusions 16 are arranged at either end of the body 11 of the adaptor 100 with the primary protrusion 14 in a longitudinal centre of the body 11. However, any other arrangement of the primary protrusion 14 and secondary protrusions 16 is also considered, including arrangements with multiple primary protrusions 14 and/or a single secondary protrusion 16.

The secondary protrusions 16 may be shaped to engage with the further rotor bore 22 which may be at an angle to the body 11 of the adaptor 100. This can be particularly relevant where the primary protrusion 16 engages in a generally parallel manner with its rotor bore 22 such as shown in FIG. 6. To accommodate this, the secondary protrusions 16 may be angled with respect to the primary protrusion 14. An example of how this works is shown in FIG. 7. As a result of this angle, the secondary protrusion 16 is able to effectively engage with a rotor bore 22 that is not perpendicular to the body 11.

The angle of the secondary protrusions 16 may be selected based on the rotor 200 which the adaptor 100 is intended to be used with.

The secondary protrusions 16 may have a proximal end at the body 11, and a distal end away from the body 11. The secondary protrusions 16 may have a taper towards this distal end. That is, the secondary protrusions 16 may be tapered towards the distal end. This means that the secondary protrusions 16 can decrease in diameter towards the distal end. At the proximal end, the secondary protrusions 16 may have an outer diameter generally corresponding to the inner diameter of the rotor bore 22. Further, each secondary protrusion 16 may be shorter than the primary protrusion 14.

The secondary protrusion 14 may span the entire diameter of the opening of the rotor bore 22, then taper along one of its internal sides to a point as shown in FIG. 7. In this sense, the secondary protrusions 16 can help to locate and support the adaptor 100 within the rotor 200. FIGS. 6 and 7 show how a particular example adaptor 100 using both primary protrusions 14 and secondary protrusions 16 can be located within a rotor 200.

In further examples, the rotor 100 may comprise one or more further protrusions such as tertiary protrusions. These tertiary protrusions can take any suitable shape to engage one or more rotor bores 22 of the rotor 200. These tertiary protrusions may be generally the same or similar to the primary protrusion 14 and/or secondary protrusions 16 discussed above.

In certain examples, a rotor kit may also be provided. This can take the form of both a centrifuge rotor 200 and an adaptor 100 as described above (or any other suitable adaptor). The centrifuge rotor 200 includes a plurality of rotor bores 22, which may for example be arranged in a circular arrangement. The primary protrusion 16 and/or secondary protrusions 14 of the adaptor 100 may be sized and shaped to correspond to the particular rotor 200 and rotor bores 22 to thereby provide a rotor kit which allows for the rotor 200 to be readily used for a multitude of different sample containers.

The adaptor 100 of this rotor kit may, in general, comprise: a body 11 comprising a plurality of bores 12 arranged in a row each having a first diameter and each bore 12 for receiving a first sample container; and a primary protrusion 14 extending from the body 11, the primary protrusion 14 having a second diameter greater than the first diameter and the primary protrusion 14 for being received in a rotor bore 22 of a centrifuge rotor 200 (such as the rotor bores 22 of the centrifuge rotor 200 of the kit), the rotor bore 22 for receiving second sample containers. This adaptor 100 may further comprise any of the modifications discussed herein.

In further examples, a centrifuge may also be provided with this rotor kit to thereby form a centrifuge kit. This further incorporates the centrifuge to provide a centrifuge kit which can be readily used for a multitude of different sample containers.

The adaptor 100 of this centrifuge kit may, in general, comprise: a body 11 comprising a plurality of bores 12 arranged in a row each having a first diameter and each bore 12 for receiving a first sample container; and a primary protrusion 14 extending from the body 11, the primary protrusion 14 having a second diameter greater than the first diameter and the primary protrusion 14 for being received in a rotor bore 22 of a centrifuge rotor 200 (such as the rotor bores 22 of the centrifuge rotor 200 of the kit), the rotor bore 22 for receiving second sample containers. This adaptor 100 may further comprise any of the modifications discussed herein.

The adaptor 100 described herein (or any other suitable adaptor) can also be used in a method of adapting a centrifuge rotor 200. The centrifuge rotor 200 having one or more, preferably a plurality, of rotor bores 22. The suitable adaptor 100 is provided. A primary protrusion 14 of the adaptor 100 is then inserted into a rotor bore 22 of the plurality of rotor bores 22 of the rotor 200.

The adaptor 100 of this method may, in general, comprise: a body 11 comprising a plurality of bores 12 arranged in a row each having a first diameter and each bore 12 for receiving a first sample container; and a primary protrusion 14 extending from the body 11, the primary protrusion 14 having a second diameter greater than the first diameter and the primary protrusion 14 for being received in a rotor bore 22 of a centrifuge rotor 200 (such as the rotor bores 22 of the centrifuge rotor 200 of the kit), the rotor bore 22 for receiving second sample containers. This adaptor 100 may further comprise any of the modifications discussed herein.

The adaptor 100 described herein (or any other suitable adaptor) can also be used in a method of processing a sample container in a centrifuge, the centrifuge comprising a centrifuge rotor 200 comprising one or more, preferably a plurality, of rotor bores 22. The suitable adaptor 100 is provided. A primary protrusion 14 of the adaptor 100 is then inserted into a rotor bore 22 of the plurality of rotor bores 22 of the rotor 200. A sample container is inserted into the adaptor bore 12 of the adaptor 100. This sample container may, for example, be a PCR tube 44 which may be in a PCR strip 400. The centrifuge is then operated to rotate the rotor 200 and thereby centrifuge the sample container.

Again, the adaptor 100 of this method may, in general, comprise: a body 11 comprising a plurality of bores 12 arranged in a row each having a first diameter and each bore 12 for receiving a first sample container; and a primary protrusion 14 extending from the body 11, the primary protrusion 14 having a second diameter greater than the first diameter and the primary protrusion 14 for being received in a rotor bore 22 of a centrifuge rotor 200 (such as the rotor bores 22 of the centrifuge rotor 200 of the kit), the rotor bore 22 for receiving second sample containers. This adaptor 100 may further comprise any of the modifications discussed herein.

In this manner, an adaptor 100 for a centrifuge rotor 200 and corresponding methods are provided.

Each feature disclosed in this specification, unless stated otherwise, may be replaced by alternative features serving the same, equivalent, or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” means “one or more”. Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

Moreover, although aspects and embodiments have primarily been described with reference to physical apparatus, the disclosure also provides methods of manufacturing and using such apparatus. For example, methods of manufacturing any of the apparatus described herein are provided, as are methods of using the apparatus described herein.

1. An adaptor for a centrifuge rotor, comprising:
a body comprising a plurality of bores arranged in a row each having a first diameter and each bore for receiving a first sample container; and
a primary protrusion extending from the body, the primary protrusion having a second diameter and the primary protrusion for being received in a rotor bore of a centrifuge rotor, the rotor bore for receiving second sample containers.

2. The adaptor of claim 1, wherein the plurality of bores comprises three or more bores.

3. The adaptor of claim 1, wherein the second diameter is greater than the first diameter.

4. The adaptor of claim 1, wherein the body extends transverse to the primary protrusion.

5. The adaptor of claim 1, wherein the first diameter corresponds to an outer diameter of a PCR tube.

6. The adaptor of claim 1, wherein the second diameter corresponds to an outer diameter of a 0.5 millilitre to 2 millilitre sample container.

7. The adaptor of any preceding claim, wherein the primary protrusion is formed as a cylindrical protrusion.

8. The adaptor of claim 1, comprising a plurality of primary protrusions including the primary protrusion, each primary protrusion for being received in a rotor bore of a centrifuge rotor and being arranged on a segment of a circular arc.

9. The adaptor of claim 1, further comprising at least one secondary protrusion for being received in a further rotor bore of the centrifuge rotor.

10. The adaptor of claim 9, wherein each secondary protrusion is at least one of:
(a) angled with respect to the primary protrusion, (b) tapered towards its distal end, or (c) shorter than the primary protrusion.

11. The adaptor of claim 9, comprising two secondary protrusions, with the primary protrusion arranged centrally.

12. A rotor kit, comprising:
a centrifuge rotor comprising a plurality of rotor bores; and
the adaptor of claim 1.

13. A centrifuge kit, comprising:
a centrifuge;
a centrifuge rotor comprising a plurality of rotor bores; and
the adaptor of claim 1.

14. A method of adapting a centrifuge rotor comprising a plurality of rotor bores, the method comprising:
providing an adaptor according to claim 1;
inserting the primary protrusion into a rotor bore of the plurality of rotor bores.

15. A method of processing a sample container in a centrifuge, the centrifuge comprising a centrifuge rotor comprising a plurality of rotor bores, the method comprising:
providing an adaptor according to claim 1;
inserting the primary protrusion into a rotor bore of the plurality of rotor bores;
inserting the sample container into the bore of the adaptor; and
operating the centrifuge to rotate the centrifuge rotor.
